(19) United States
(12) Patent Application Publication
(10) Pub. No.: US 2018/0114628 A1
(43) Pub. Date: Apr. 26, 2018

(54) WIRE-WOUND INDUCTOR

(71) Applicant: Murata Manufacturing Co., Ltd., Kyoto-fu (JP)

(72) Inventor: Masashi MIYAMOTO, Nagaokakyo-shi (JP)

(73) Assignee: Murata Manufacturing Co., Ltd., Kyoto-fu (JP)

(21) Appl. No.: 15/847,966

(22) Filed: Dec. 20, 2017

Related U.S. Application Data
(63) Continuation of application No. PCT/JP2016/057487, filed on Mar. 10, 2016.

(30) Foreign Application Priority Data
Jul. 9, 2015 (JP) 2015-137544

(51) Int. Cl. H01F 27/28

(52) U.S. Cl. CPC H01F 27/2823

(57) ABSTRACT

When dimensions in a cross section of a wire measured in a major axis direction and in a minor axis direction, which are orthogonal to each other, are defined as a major axis direction dimension and a minor axis direction dimension, respectively, and ellipticity of the cross section is expressed as (major axis direction dimension)/(minor axis direction dimension), the ellipticity of the cross section is greater than or equal to 1.3 and less than or equal to 3.0. The wire is helically wound with a single layer around a winding core portion in a state where the major axis direction extends along an axial direction of the winding core portion.

### CROSS REFERENCE TO RELATED APPLICATIONS

This application claims benefit of priority to Japanese Patent Application 2015-137544 filed Jul. 9, 2015, and to International Patent Application No. PCT/JP2016/057487 filed Mar. 10, 2016, the entire content of which is incorporated herein by reference.

### TECHNICAL FIELD

The present disclosure relates to wire-wound inductors and in particular to improvement in the form and the winding mode of wire in a wire-wound inductor.

### BACKGROUND

One example of wire-wound inductors of interest to the present disclosure is described in Japanese Unexamined Patent Application Publication No. 2007-311525. FIG. 8 illustrates in perspective view an outer appearance of the wire-wound inductor described in Japanese Unexamined Patent Application Publication No. 2007-311525.

A wire-wound inductor 1 illustrated in FIG. 8 includes a core 2 and a wire 3. The core 2 includes a winding core portion 4 and first and second flange portions 5 and 6 on respective end portions of the winding core portion 4. The wire 3 is helically wound around the winding core portion 4. First and second terminal electrodes 7 and 8 are disposed on the first and second flange portions 5 and 6, respectively. Respective end portions of the above-described wire 3 are connected to the first and second terminal electrodes 7 and 8.

In FIG. 8, a resin sealer 9 including magnetic powder as a filler is indicated by broken lines.

FIG. 8 illustrates the wire-wound inductor 1 in an attitude in which the terminal electrodes 7 and 8 face upward. That is, the wire-wound inductor 1 is to be mounted in the state where the upper surface in FIG. 8 faces a mounting board side.

FIG. 9 is a cross-sectional view that illustrates a portion of the wire 3 illustrated in FIG. 8 in an enlarged manner. As clearly illustrated in FIG. 9, the wire 3 can be provided as a covered rectangular conducting wire including a conducting wire portion 10 made of, for example, copper as a conductor portion and a covering portion 11 insulating and covering the conducting wire portion 10.

As is evident from FIGS. 8 and 9, the wire 3 is edgewise wound around the winding core portion 4 in a state where the minor axis direction in its cross section extends along the axial direction of the winding core portion 4. Such cross-sectional form and winding mode of the wire 3 is adopted with the aim of enhancing a Q of the wire-wound inductor 1, and the enhancement of the Q is achieved by increasing the space factor of the conducting wire portion 10 of the wire 3 and reducing the direct-current resistance.

As illustrated in FIGS. 8 and 9, the wire 3 is wound around the winding core portion 4 in a close contact state. This can increase the coupling coefficient of the magnetic field and allows the inductance to be efficiently obtained. This can also contribute to the enhancement of the Q.

### SUMMARY

### Technical Problem

However, the enhancement of the Q in the wire-wound inductor 1 described above can be expected only when it is used at low frequencies. When the wire-wound inductor 1 is used at high frequencies, for example, at equal to or higher than 10 MHz, a high Q is not obtainable therefrom.

When the wire-wound inductor 1 is used at high frequencies, the skin effect appears in the wire 3. Thus, when the winding core portion 4 is made of a nonmagnetic material, a current flows only in a surface region 12 positioned on an internal diameter side near the winding core portion 4 in the conducting wire portion 10 (that region is schematically indicated by hatching on the internal diameter side in the conducting wire portion 10 in FIG. 9). Hence, a major portion other than the surface region 12 on the internal diameter side in the conducting wire portion 10 does not contribute to flowing the current. That is, the major portion of the conducting wire portion 10 is useless. In addition, the major portion on the external diameter side in the conducting wire portion 10 blocks a return of magnetic flux produced by the wire 3 and even is a cause of an increase in magnetic resistance.

When the winding core portion 4 is made of a magnetic material, because of the above-described skin effect, a current flows only in a surface region 13 positioned on the external diameter side, which is the opposite side to the winding core portion 4 side, in the conducting wire portion 10 (that region is schematically indicated by hatching on the external diameter side in the conducting wire portion 10 in FIG. 9). Hence, a major portion other than the surface region 13 on the external diameter side in the conducting wire 10 does not contribute to flowing the current. That is, the major portion of the conducting wire portion 10 is useless. In addition, the major portion on the internal diameter side in the conducting wire portion 10 blocks generation of magnetic flux by the wire 3 and even is a cause of an increase in magnetic resistance.

In the present specification, the “high frequencies” indicate a frequency region at or above a frequency where the depth at which the skin effect appears is smaller than the radius of the conducting wire.

An object of the present disclosure is to provide a wire-wound inductor capable of achieving a higher Q at high frequencies.

### Solution to Problem

The present disclosure is directed to a wire-wound inductor including a core including a winding core portion and a wire wound around the winding core portion, the wire having a flattened shape in cross section.

In the wire-wound inductor according to the present disclosure, when dimensions in a cross section of the wire measured in a major axis direction and in a minor axis direction, which are orthogonal to each other, are defined as a major axis direction dimension and a minor axis direction dimension, respectively, and ellipticity of the cross section is expressed as (major axis direction dimension)/(minor axis direction dimension), the ellipticity of the cross section is greater than or equal to 1.3 and less than or equal to 3.0, and the wire is helically wound with a single layer around the winding core portion in a state where the major axis direction extends along an axial direction of the winding core portion.

A high frequency current flows only in a surface region on an internal diameter side or on an external diameter side of the wire because of the skin effect. With the use of the above-described configuration, the surface region in which the high frequency current flows is located along a side extending in the major axis direction in cross section of the wire. Accordingly, the ratio of the cross-sectional area of the portion in which the high frequency current flows under the skin effect to the total cross-sectional area of the wire can be increased.

In the present disclosure, the wire may preferably be wound in a state where space is present between adjacent sections of the wire around the winding core portion. If the wire is wound in a state where the adjacent sections are in close contact with each other around the winding core portion, as described in Japanese Unexamined Patent Application Publication No. 2007-311525, an eddy-current loss may easily occur at high frequencies. In the state where the wire is wound such that the adjacent sections are in close contact with each other, even though the advantage of increasing the inductance acquisition efficiency can be expected, a loss caused by an eddy current at high frequencies is increased to the degree where that advantage is weakened, and this results in a decreased Q. Accordingly, as previously described, when the wire is wound in the state where space is present between the adjacent sections around the winding core portion, the decrease in Q at high frequencies can be suppressed.

The above-described advantage can also be provided when the configuration described below is adopted.

That is, in the present disclosure, a distance between adjacent sections of a conducting wire portion of the wire around the winding core portion may preferably be greater than or equal to 20 μm and less than or equal to 100 μm. In particular, when the distance between the adjacent sections in the conducting wire portion of the wire is at or above 20 μm, the occurrence of eddy currents caused by proxy effect of the conducting wire portion can be suppressed more reliably, and when that distance is at or below 100 μm, a decrease in inductance acquisition efficiency resulting from too long a distance can be suppressed.

The configuration in which the distance between the adjacent sections in the conducting wire portion of the wire around the winding core portion is greater than or equal to 20 μm and less than or equal to 100 μm is or is not compatible with the configuration in which the wire is wound in the state where space is present between adjacent sections of the wire around the winding core portion, as described below.

Typically, a wire is provided as a covered conducting wire including a conducting wire portion made of, for example, copper as a conductor portion and a covering portion insulating and covering the conducting wire portion. As in this case, in which the wire is made of the covered conducting wire, typically, when the distance between the adjacent sections of the conducting wire portion of the wire around the winding core portion is greater than or equal to 20 μm and less than or equal to 100 μm, space in which the amount corresponding to the thickness of the covering portion is reduced from that distance is present between the adjacent sections of the wire around the winding core portion. This is the case where the above-described two configurations are compatible with each other. Depending on the thickness of the covering portion, there may be a case where the configuration in which the distance between the adjacent sections of the conducting wire portion of the wire around the winding core portion is greater than or equal to 20 μm and less than or equal to 100 μm is satisfied, but only the covering portion is present between the adjacent sections in the wire around the winding core portion and no space is present. This is the case where the above-described two configurations are not compatible with each other.

In the case where the wire is not insulated or covered and is composed of only the conducting wire portion as the conductor portion, when the distance between the adjacent sections of the conducting wire portion of the wire around the winding core portion is greater than or equal to 20 μm and less than or equal to 100 μm, space whose size is equal to this distance is present between the adjacent sections of the wire around the winding core portion. In such an embodiment, inevitably, the above-described two configurations are compatible with each other.

### Advantageous Effects of Disclosure

According to the present disclosure, because the wire is wound around the winding core portion in the state where the major axis direction extends along the axial direction of the winding core portion, the surface region on the internal diameter side in which a high frequency current flows is located along a side extending in the major axis direction in cross section of the wire. Thus, the ratio of the cross-sectional area of the portion in which the high frequency current flows under the skin effect to the total cross-sectional area of the wire can be increased, that is, the effective cross-sectional area can be widened, and accordingly, a high Q is obtainable.

As previously described, when the wire is wound around the winding core portion in the state where the major axis direction extends along the axial direction of the winding core portion, the internal diameter dimension of the wire, that is, the external diameter dimension of the winding core portion can be larger than that when the wire is wound in the state where the minor axis direction extends along the axial direction of the winding core portion in the case where the wire-wound inductor having the external diameter of the same dimension is configured. Thus the path of magnetic flux can be widened, and this can also contribute to the enhancement of the Q.

In the present disclosure, the ellipticity of the cross section of the wire is greater than or equal to 1.3 and less than or equal to 3.0. When the ellipticity is in that range, a degradation in Q caused by the skin effect can be suppressed, and a decrease in inductance acquisition efficiency can be suppressed. This can also contribute to the enhancement of the Q.

According to the present disclosure, because the wire is helically wound around the winding core portion with a single layer, the occurrence of eddy currents caused by proxy effect of the conducting wire portion of the wire in the case where the wire is wound with multiple layers can be avoided. This can also contribute to the enhancement of the Q.

### BRIEF DESCRIPTION OF DRAWINGS

FIG. 1 is a perspective view that illustrates an outward appearance of a wire-wound inductor 21 according to a first embodiment of the present disclosure and illustrates it such that a surface supposed to face a mounting board side faces upward.

FIG. 2 is a cross-sectional view of the wire-wound inductor 21 illustrated in FIG. 1 taken along the line II-II.

FIG. 3 is an enlarged view of a portion of the wire-wound inductor 21 illustrated in the cross-sectional view of FIG. 2.

FIG. 4 illustrates a relationship between “ellipticity” of a cross section of a wire and “Q×L acquisition efficiency” for the wire-wound inductor.

FIG. 5 illustrates a relationship between “distance” between adjacent sections of a conducting wire portion of the wire around a winding core portion and “Q” for the wire-wound inductor.

FIG. 6 is a cross-sectional view for describing a second embodiment of the present disclosure and illustrating a cross-sectional shape of a wire 23a together with a portion of a winding core portion 24.

FIG. 7 is a cross-sectional view for describing a third embodiment of the present disclosure and illustrating a cross-sectional shape of a wire 23b together with the portion of the winding core portion 24.

FIG. 8 is a perspective view that illustrates an outward appearance of a wire-wound inductor 1 described in Japanese Unexamined Patent Application Publication No. 2007-311525 and illustrates it such that a surface supposed to face a mounting board side faces upward.

FIG. 9 is a cross-sectional view that illustrates a portion of the wire-wound inductor 1 illustrated in FIG. 8 in an enlarged manner.

### DETAILED DESCRIPTION

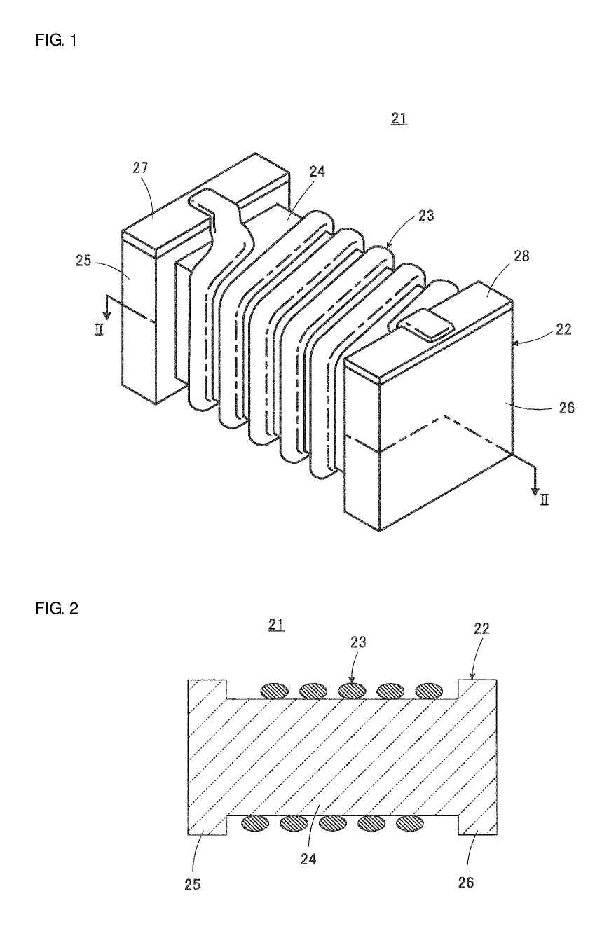

A wire-wound inductor 21 according to a first embodiment of the present disclosure will be described with reference to FIGS. 1 to 3.

The wire-wound inductor 21 includes a core 22 and a wire 23. The core 22 includes a winding core portion 24 and first and second flange portions 25 and 26 on respective end portions of the winding core portion 24. The wire 23 is helically wound around the winding core portion 24. First and second terminal electrodes 27 and 28 are disposed on the first and second flange portions 25 and 26, respectively.

Respective end portions of the wire 23 are connected to the first and second terminal electrodes 27 and 28. In that connection, a configuration described below may preferably be adopted. That is, each of the terminal electrodes 27 and 28 includes a tin layer as its outermost layer. The respective end portions of the wire 23 are bonded to the terminal electrodes 27 and 28 by thermocompression bonding, thereby firmly brazing the respective end portions to the terminal electrodes 27 and 28 while making the end portions deformed.

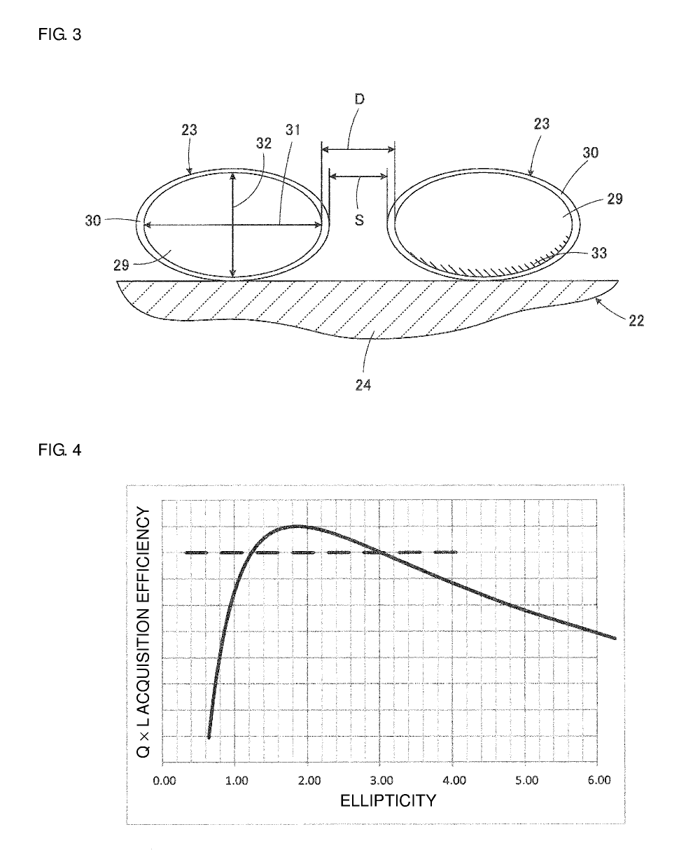

When the wire 23 includes a conducting wire portion 29 made of, for example, copper as a conductor portion and a covering portion 30 insulating and covering the conducting wire portion 29 and made of, for example, epoxy resin, as illustrated in FIG. 3, by performing thermocompression bonding in the above-described connecting process, the conducting wire portion 29 of the wire 23 is brazed to the terminal electrodes 27 and 28, and simultaneously the conducting wire portion 29 is removed.

The core 22 is made of an insulator ceramic, such as aluminum oxide, or a magnetic substance, such as ferrite. Each of the illustrated winding core portion 24 and flange portions 25 and 26 has a rectangular shape in cross section. The winding core portion 24 and flange portions 25 and 26 may have other polygonal shapes or rounded shapes.

The wire 23 wound around the winding core portion 24 has a flattened shape in cross section. In the present embodiment, the flattened shape provided to the cross section of the wire 23 is an oval or substantially oval shape. The cross-sectional shape of the wire 23 will be described in detail with reference to FIG. 3.

When the dimensions in a cross section of the wire 23 measured in a major axis direction 31 and a minor axis direction 32, which are orthogonal to each other, are defined as a major axis direction dimension and a minor axis direction dimension, respectively, and the ellipticity of the cross section is expressed as (major axis direction dimension)/(minor axis direction dimension), the ellipticity of the cross section is greater than or equal to 1.3 and less than or equal to 3.0. The reason for limiting this numerical range will be described below with reference to FIG. 4.

When the wire includes the conducting wire portion 29 and the covering portion 30, as in the wire 23 illustrated in FIG. 3, reading the above-described “wire 23” as the “conducting wire portion 29” is more correct for calculating (major axis direction dimension)/(minor axis direction dimension). However, in actuality, the thickness of the covering portion 30 is approximately 5 to 10 μm and is small enough to be almost negligible. There is no substantial difference between the calculation of the ellipticity using the major axis direction dimension and minor axis direction dimension of the cross section of the wire 23 and that using the dimensions of the conducting wire portion 29.

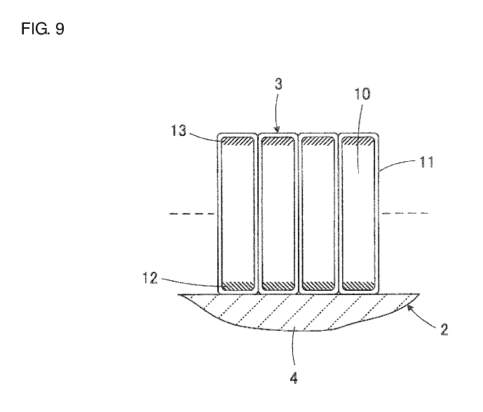

The wire 23 is wound around the winding core portion 24 in the state where the major axis direction 31 of the cross section extends along the axial direction of the winding core portion 24. That is, the wire 23 is wound around the winding core portion 24 such that a side extending in the major axis direction 31 in its cross section faces the internal diameter side. Such a direction of the cross section of the wire 23 differs from that described in Japanese Unexamined Patent Application Publication No. 2007-311525 illustrated in FIGS. 8 and 9 by substantially 90 degrees.

When the winding core portion 24 is made of a nonmagnetic material, a high-frequency current flows only in a surface region 33, hatched in FIG. 3, on the internal diameter side of the wire 23 because of the skin effect. With the above-described configuration, the surface region 33 on the internal diameter side in which the high-frequency current flows is located along the side extending in the major axis direction 31 in cross section of the wire 23. Accordingly, the ratio of the cross-sectional area of the portion in which the high-frequency current flows under the skin effect (surface region 33) to the total cross-sectional area of the wire 23 can be increased, that is, the effective cross-sectional area can be widened, and thus a high Q is obtainable.

When the winding core portion 24 is made of a magnetic material, its illustration being omitted, the location in which a high-frequency current flows is in a surface region on the external diameter side, which is opposite to the surface region 33 on the internal diameter side of the wire 23 when the winding core portion 24 is made of a nonmagnetic material. Even in this case, substantially the same advantages described above are obtainable.

When the wire 23 is wound around the winding core portion 24 in the state where the major axis direction 31 extends along the axial direction of the winding core portion 24, as described above, the internal diameter dimension of the wire 23, that is, the external diameter dimension of the winding core portion 24 can be larger than that when the wire 23 is wound in the state where the minor axis direction extends along the axial direction of the winding core portion in the case where the wire-wound inductor having the external diameter of the same dimension is configured. Thus the path of magnetic flux can be widened, and this can also contribute to the enhancement of the Q.

The wire 23 is helically wound around the winding core portion 24 with not multiple layers but a single layer. With this configuration, the occurrence of eddy currents caused by proxy effect of the conducting wire portion of the wire in the case where the wire 23 is wound with multiple layers can be avoided. This can also contribute to the enhancement of the Q.

As illustrated in FIG. 3, the wire 23 may preferably be wound around the winding core portion 24 in the state where space S is present between the adjacent sections. The winding state where the wire 23 is wound with the space S between the adjacent sections can also be seen from FIGS. 1 and 2. In the illustrated structure, only air exists in the space S. A material, such as a dielectric, other than the covering portion 30 may also exist in at least a portion of the space S.

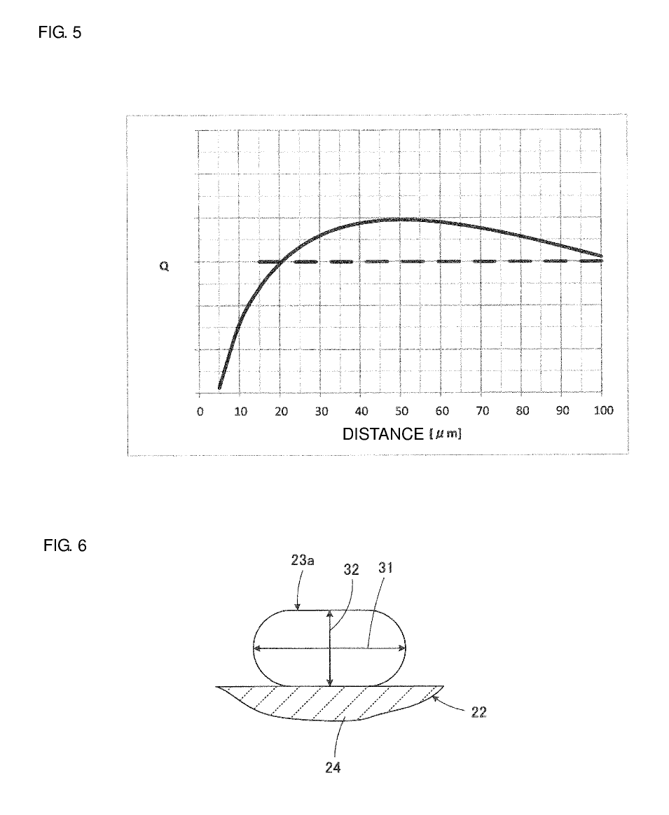

As illustrated in FIG. 3, the distance between the adjacent sections in the conducting wire portion 29 as the conductor portion of the wire 23 around the winding core portion 24 may preferably be greater than or equal to 20 μm and less than or equal to 100 μm and more preferably approximately 50 μm. The reason for limiting this numerical range will be described below with reference to FIG. 5.

In the present embodiment, because the wire 23 is wound around the winding core portion 24 in the state where the space S is present between the adjacent sections, it is not necessary to insulate and cover the wire 23, and the wire 23 may be made of only the conducting wire portion 29 as the conductor portion. In that case, the size of the space S is equal to the distance D.

The reason for selecting the range greater than or equal to 1.3 and less than or equal to 3.0 for the ellipticity of the cross section of the wire 23 is described with reference to FIG. 4. FIG. 4 illustrates a relationship between “ellipticity” of the cross section of the wire 23 and “Q×L acquisition efficiency.” In FIG. 4, the lower limit of a preferable range of the “Q×L acquisition efficiency” is indicated by broken lines. The range where values of the “Q×L acquisition efficiency” at or above the broken lines are obtainable is the range where the ellipticity is greater than or equal to 1.3 and less than or equal to 3.0.

FIG. 4 reveals that when the ellipticity is in the range greater than or equal to 1.3 and less than or equal to 3.0, as described above, a degradation in Q caused by the skin effect can be suppressed, and a decrease in inductance acquisition efficiency can be suppressed. This can contribute to the enhancement of the Q.

The data illustrated in FIG. 4 is based on a wire-wound inductor having the structure illustrated in FIG. 1 and with outer dimensions of 1.6 mm×0.8 mm×0.8 mm. It has been confirmed that substantially the same data is obtainable with a wire-wound inductor with outer dimensions of 2.5 mm×2.0 mm×2.0 mm.

Next, the reason for preferably selecting the range greater than or equal to 20 μm and less than or equal to 100 μm for the distance D between the adjacent sections of the conducting wire portion 29 of the wire 23 around the winding core portion 24 is described with reference to FIG. 5. FIG. 5 illustrates a relationship between “distance” between the adjacent sections of the conducting wire portion 29 of the wire 23 around the winding core portion 24 and “Q.” In FIG. 5, the lower limit of a preferable range of the “Q” is indicated by broken lines. The range where values of the “Q” at or above the broken lines are obtainable is the range where the distance D is greater than or equal to 20 μm and less than or equal to 100 μm. The highest “Q” is obtained when the distance D is in the vicinity of 50 μm.

As described above, when the distance between the adjacent sections of the conducting wire portion 29 of the wire 23 is at or above 20 μm, the occurrence of eddy currents caused by proxy effect of the conducting wire portion can be suppressed more reliably, and when that distance is at or below 100 μm, a decrease in inductance acquisition efficiency resulting from too long a distance can be suppressed. Thus as illustrated in FIG. 5, a high Q can be maintained.

The data illustrated in FIG. 5 is also based on a wire-wound inductor having the structure illustrated in FIG. 1 and with outer dimensions of 1.6 mm×0.8 mm×0.8 mm, as in the data illustrated in FIG. 4. It has been confirmed that substantially the same data is obtainable with a wire-wound inductor with outer dimensions of 2.5 mm×2.0 mm×2.0 mm.

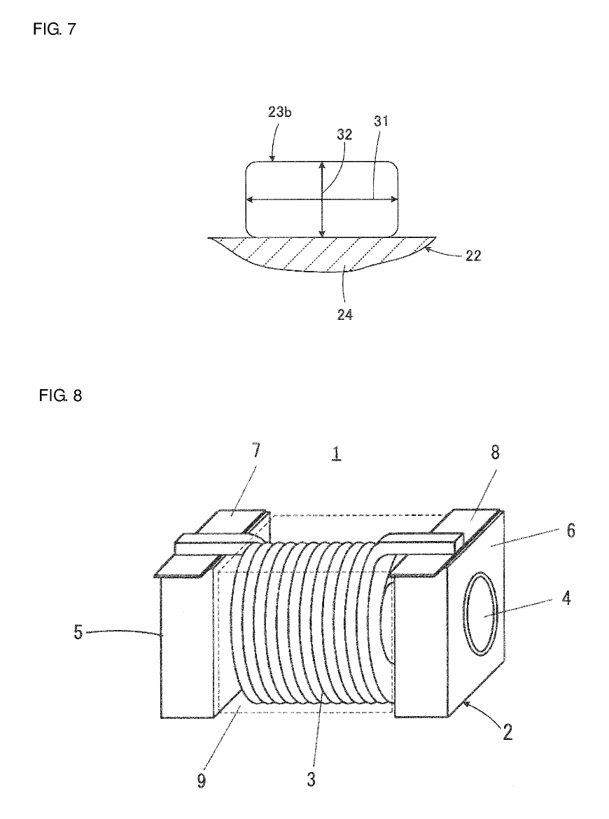

FIGS. 6 and 7 are illustrations for describing second and third embodiments of the present disclosure, respectively, and illustrate representative variations of the cross-sectional shape of the wire. The wire may include the conducting wire portion and the covering portion, as previously described, or may include only the conducting wire portion without including the covering portion. The illustration of the covering portion of the wire is omitted in FIGS. 6 and 7.

In FIGS. 6 and 7, the same reference numerals are used in the elements corresponding to the elements illustrated in, for example, FIG. 3, and the redundant description is omitted.

In the above-described first embodiment, the flattened shape provided to the cross section of the wire 23 is an oval or substantially oval shape. Unlike this, a wire 23a illustrated in FIG. 6 has an elongated circular shape in cross section. A wire 23b illustrated in FIG. 7 has a rounded rectangular shape in cross section. The cross-sectional shape of the wire used in the present disclosure is not limited to the illustrated ones, may be a shape between two shapes among the illustrated ones, and can have any flattened shape.

In particular, in the case of a wire-wound inductor used at high frequencies, the wire may preferably have a shape in which its end portions in the major axis direction 31 are rounded as a whole, as in the wire 23 illustrated in FIG. 3 or the wire 23a illustrated in FIG. 6. This is because in the case of the wire 23 or 23a, in which its end portions in the major axis direction 31 are rounded as a whole, the obstruction of a return of magnetic flux traveling along the central axis of the winding core portion 24 is more reduced, and thus a higher Q is obtainable at high frequencies.

In the case of a wire-wound inductor used at relatively low frequencies, the wire may preferably have a larger cross-sectional area, as in the wire 23b illustrated in FIG. 7. This is not intended to deny the use of the wire 23b illustrated in FIG. 7 in a wire-wound inductor for use at high frequencies.

The present disclosure has been described above in relation to the illustrated embodiments. The illustrated embodiments are illustrative. It is to be noted that partial replacement or combination of the configurations among the different embodiments can be made.

1. A wire-wound inductor comprising:
a core including a winding core portion; and
a wire wound around the winding core portion,
wherein the wire has a flattened shape in cross section,
when dimensions in a cross section of the wire measured in a major axis direction and in a minor axis direction, which are orthogonal to each other, are defined as a major axis direction dimension and a minor axis direction dimension, respectively, and ellipticity of the cross section is expressed as (major axis direction dimension)/(minor axis direction dimension),
the ellipticity of the cross section is greater than or equal to 1.3 and less than or equal to 3.0, and
the wire is helically wound with a single layer around the winding core portion in a state where the major axis direction extends along an axial direction of the winding core portion.

2. The wire-wound inductor according to claim 1, wherein the wire is wound in a state where space is present between adjacent sections of the wire around the winding core portion.

3. The wire-wound inductor according to claim 1, wherein a distance between adjacent sections of a conducting wire portion of the wire around the winding core portion is greater than or equal to 20 μm and less than or equal to 100 μm.

4. The wire-wound inductor according to claim 2, wherein a distance between adjacent sections of a conducting wire portion of the wire around the winding core portion is greater than or equal to 20 μm and less than or equal to 100 μm.
